(19) United States
(12) Patent Application Publication
(10) Pub. No.: US 2020/0368723 A1
(43) Pub. Date: Nov. 26, 2020

(54) NANOFIBER AGGREGATE FOR FAT ADSORPTION, METHOD FOR ESTIMATING FAT ADSORPTION RATE OF NANOFIBER AGGREGATE FOR FAT ADSORPTION, AND METHOD FOR ESTIMATING VOLUME OF NANOFIBER AGGREGATE FOR FAT ADSORPTION FOLLOWING FAT ADSORPTION

(71) Applicant: M-TECHX INC., Tokyo (JP)

(72) Inventors: Hiroyoshi SOTA, Tokyo (JP); Morihiko IKEGAYA, Tokyo (JP); Kenichi URABE, Tokyo (JP); Takatsugu ECHIZENYA, Tokyo (JP); Toshiki HIROGAKI, Kyotanabe-shi, Kyoto (JP); Wei WU, Kyotanabe-shi, Kyoto (JP); Yoshiaki ISHII, Tokyo (JP)

(21) Appl. No.: 16/627,663

(22) PCT Filed: Jun. 28, 2018
(86) PCT No.: PCT/JP2018/024743

§ 371 Date: Aug. 13, 2020

Related U.S. Application Data
(60) Provisional application No. 62/527,761, filed on Jun. 30, 2017.

(51) Int. Cl. B01J 20/28; B01J 20/26; G01F 22/00; B01J 20/30

(52) U.S. Cl. CPC B01J 20/28007; B01J 20/261; B01J 20/28038; B82Y 30/00; B01J 20/28023; B01J 20/3028; G01F 22/00

(57) ABSTRACT

An oil and fat adsorbing nanofiber laminate in which an oil suction rate is secured and a suction speed is effectively increased, a method for estimating an oil and fat suction rate of an oil and fat adsorbing nanofiber aggregate, and a method for estimating a volume after oil and fat adsorption are provided. An oil and fat adsorbing nanofiber aggregate 1 has an average fiber diameter d of 1000 nm or more and 2000 nm or less and a bulk density ρ_{b} of 0.01 g/cm³ or more and 0.2 g/cm3 or less. The oil and fat adsorbing nanofiber aggregate 1 is capable of securing a suction rate of oil and fat and effectively increasing a suction speed.

### TECHNICAL FIELD

The present invention relates to a nanofiber aggregate used for oil and fat adsorption, a method for estimating an oil and fat suction rate of an oil and fat adsorbing nanofiber aggregate, and a method for estimating a volume after oil and fat adsorption.

### BACKGROUND ART

Oil and fat adsorbing materials are used for, for example, adsorption and removal of oils on a water surface, such as a sea surface, a lake surface, a pond surface, a river surface, and a reservoir surface, and oils spilled on a floor, a road, and the like. Oil and fat adsorbing materials are also used for adsorption and removal of oil and fat in contaminated water from kitchens of cafeterias, restaurants, and the like.

PTL 1 discloses a conventional oil and fat adsorbing material. The oil and fat adsorbing material is a laminate of polypropylene fibers with a fiber diameter from 100 nm to 500 nm.

### CITATION LIST

### Patent Literature

PTL 1: JP 2013-184095 A

### SUMMARY OF INVENTION

### Technical Problem

Indicators of performance of such an oil and fat adsorbing material include a ratio of an adsorbable amount of oil and fat to its own weight (suction rate). Another example of the indicators is a suction speed of oil and fat. Since oil and fat adsorbing materials with low suction speeds have poor operating efficiency and are limited in occasions to be used in actual operation, oil and fat adsorbing materials are expected to have higher suction speeds.

It is thus an object of the present invention to provide an oil and fat adsorbing nanofiber laminate in which a suction rate of oil and fat is secured and a suction speed is effectively increased, a method for estimating an oil and fat suction rate of an oil and fat adsorbing nanofiber aggregate, and a method for estimating a volume after oil and fat adsorption.

### Solution to Problem

The present inventors focused on an average fiber diameter and a bulk density of a nanofiber aggregate used for oil and fat adsorption and made intensive investigation on relationship of these parameters with a suction rate and a suction speed. As a result, they found an average fiber diameter and a bulk density allowing an adsorption amount and a suction speed of oil and fat to be achieved at a high level and thus completed the present invention.

To achieve the above object, an oil and fat adsorbing nanofiber aggregate according to an aspect of the present invention is an oil and fat adsorbing nanofiber aggregate, wherein
the oil and fat adsorbing nanofiber aggregate satisfies formulae (i) and (ii) below where the oil and fat adsorbing nanofiber aggregate has an average fiber diameter of d and a bulk density of ρ_{b}.

1000 nm≤d≤2000 nm (i)

0.01 g/cm³≤ρ_{b}≤0.2 g/cm³ (ii)

The present invention preferably further satisfies a formula (i′) below.

1300 nm≤d≤1700 nm (i′)

The present invention preferably further satisfies a formula (ii′) below.

0.01 g/cm³≤ρ_{b}≤0.05 g/cm³ (ii′)

The present invention preferably further satisfies a formula (iii) below where the oil and fat adsorbing nanofiber aggregate has a thickness of t.

2 mm≤t≤5 mm (iii)

To achieve the above object, a method for estimating an oil and fat suction rate according to an aspect of the present invention estimates an oil and fat suction rate M/m indicating a ratio of a mass M after oil and fat adsorption to a mass m before oil and fat adsorption in an oil and fat adsorbing nanofiber aggregate, wherein the method estimates the oil and fat suction rate M/m by a formula (iv) below using a porosity η of the oil and fat adsorbing nanofiber aggregate, a density p of a fiber to constitute the oil and fat adsorbing nanofiber aggregate, and an oil and fat density ρₒ.

### [Math 1]

$$\frac{M}{m} = 1 + \frac{η {ρ}_{o}}{( 1 - η ) ρ} \qquad ( iv )$$

To achieve the above object, a method for estimating a volume after oil and fat adsorption according to an aspect of the present invention estimates a volume V after oil and fat adsorption in an oil and fat adsorbing nanofiber aggregate, wherein the method estimates an oil and fat suction rate M/m indicating a ratio of a mass M after oil and fat adsorption to a mass m before oil and fat adsorption in the oil and fat adsorbing nanofiber aggregate by a formula (iv) below using a porosity η of the oil and fat adsorbing nanofiber aggregate, a density ρ of a fiber to constitute the oil and fat adsorbing nanofiber aggregate, and an oil and fat density ρₒ and the method estimates the volume V after oil and fat adsorption by a formula (v) below using the estimate of the oil and fat suction rate M/m, the mass m before oil and fat adsorption in the oil and fat adsorbing nanofiber aggregate, the density ρ of the fiber to constitute the oil and fat adsorbing nanofiber aggregate, the oil and fat density ρₒ.

$$\begin{matrix}[ Math 2 ] & \\ \frac{M}{m} = 1 + \frac{{η}_{o}}{( 1 - η ) ρ} & ( iv ) \\ [ Math 3 ] & \\ V = \frac{( M \text{/} m ) m - m}{{ρ}_{o}} + \frac{m}{ρ} & ( v )\end{matrix}$$

### Advantageous Effects of Invention

According to the present invention, it is possible to secure the suction rate of oil and fat and effectively increase the suction speed.

In addition, according to the present invention, it is possible to predict (estimate) the oil and fat suction rate using parameters (porosity, fiber density, and oil and fat density) allowed to be obtained before oil and fat adsorption.

Still in addition, according to the present invention, it is possible to predict (estimate) the volume after oil and fat adsorption using parameters (porosity, fiber density, oil and fat density, and mass before oil and fat adsorption) allowed to be obtained before oil and fat adsorption.

### BRIEF DESCRIPTION OF THE DRAWINGS

FIG. 1 are illustrations of an oil and fat adsorbing nanofiber aggregate according to an embodiment of the present invention.

FIG. 2 is a perspective view illustrating an example of a production device used for preparation of the oil and fat adsorbing nanofiber aggregate in FIG. 1.

FIG. 3 is a side view including a partial cross section of the production device in FIG. 2.

FIG. 4 is a front view of a collecting net for deposition of nanofibers by the production device in FIG. 2.

FIG. 5 are diagrams illustrating a structural model of a fiber aggregate.

FIG. 6 are diagrams of the model in FIG. 5 taken from directions of the respective axes.

FIG. 7 is a graph illustrating relationship between porosity and interfiber distance in fiber aggregates.

FIG. 8 is a diagram schematically illustrating a state of oil and fat sucked up by a fiber aggregate.

FIG. 9 are graphs illustrating relationship between average fiber system and suction rate in fiber aggregates.

FIG. 10 is a graph illustrating relationship between test piece thickness and suction rate in fiber aggregates.

FIG. 11 is a graph illustrating relationship of average fiber system with coefficient growth rate and volume expansion ratio in fiber aggregates.

FIG. 12 is a graph illustrating relationship between bulk density and suction rate in fiber aggregates.

FIG. 13 is a graph illustrating relationship between suction time and suction height in fiber aggregates.

FIG. 14 is a graph illustrating relationship between volume expansion ratio and suction rate in fiber aggregates.

FIG. 15 is a graph illustrating relationship between porosity and suction rate in fiber aggregates.

### DESCRIPTION OF EMBODIMENTS

An oil and fat adsorbing nanofiber aggregate according to an embodiment of the present invention is described below.

### Composition of Oil and Fat Adsorbing Nanofiber Aggregate

The composition of an oil and fat adsorbing nanofiber aggregate in the present embodiment is described first.

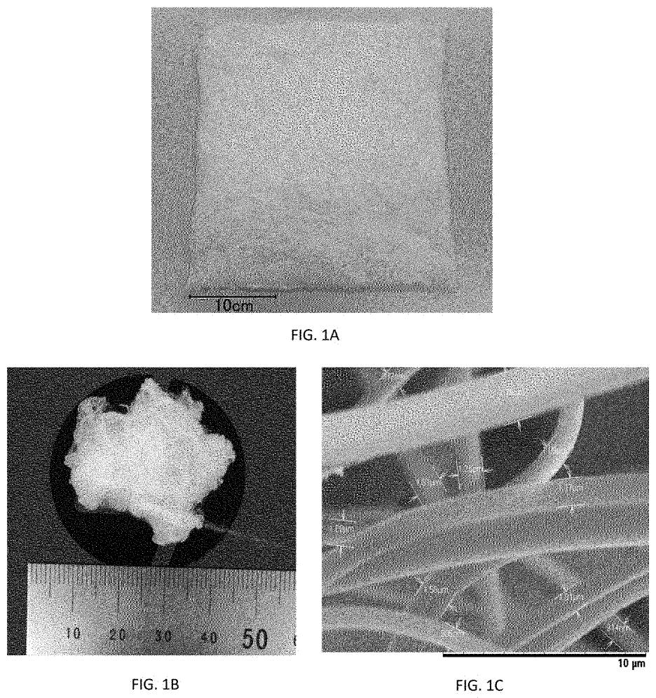

FIG. 1 are illustrations of an oil and fat adsorbing nanofiber aggregate according to an embodiment of the present invention. Specifically, FIG. 1A is a front photograph of an example of the oil and fat adsorbing nanofiber aggregate. FIG. 1B is a photograph of an example of a non-formed nanofiber aggregate. FIG. 1C is an enlarged photograph of an example of the oil and fat adsorbing nanofiber aggregate taken with an electron microscope.

An oil and fat adsorbing nanofiber aggregate 1 in the present embodiment is used for an oil and fat adsorption device that adsorbs and removes oil and fat in contaminated water from kitchens of cafeterias, restaurants, and the like. Such a device is generally referred to as a grease trap. It is required to release contaminated water from food service kitchens of restaurants, hotels, cafeterias, food service providers, and the like after purified with such a grease trap. The oil and fat adsorbing nanofiber aggregate 1 is also useful for adsorption of oils on a water surface, such as a sea surface, a lake surface, a pond surface, a river surface, and a reservoir surface, and oils spilled on a floor, a road, and the like.

The oil and fat adsorbing nanofiber aggregate 1 is composed by aggregating fine fibers with a fiber diameter on the order of nanometers, so-called nanofibers. The oil and fat adsorbing nanofiber aggregate 1 has an average fiber diameter from 1000 nm to 2000 nm and particularly preferably an average fiber diameter of 1500 nm. The oil and fat adsorbing nanofiber aggregate 1 is formed in, for example, a square mat shape as illustrated in FIG. 1A. The oil and fat adsorbing nanofiber aggregate 1 may be formed in a shape in accordance with usage and the like, such as a circular shape, a hexagonal shape, or the like other than a square shape. FIG. 1B illustrates a non-formed aggregate of nanofibers with an average fiber diameter of 1500 nm. FIG. 1C illustrates a state of the nanofiber aggregate with an average fiber diameter of 1500 nm enlarged with an electron microscope.

In the present embodiment, the nanofibers to compose the oil and fat adsorbing nanofiber aggregate 1 is constituted by a synthetic resin. Examples of the synthetic resin include polypropylene (PP), polyethylene terephthalate (PET), and the like. The nanofibers may be constituted by a material other than them.

In particular, polypropylene is water repellent and oil adsorbent. Polypropylene fiber aggregates have performance of adsorbing oil and fat several tens of times more than its own weight. Polypropylene is thus preferred as a material for the oil and fat adsorbing nanofiber aggregate 1. The numerical values disclosed by raw material suppliers as the density (material density) of polypropylene range approximately from 0.85 to 0.95. Polypropylene has a contact angle with oil and fat from 29 degrees to 35 degrees. The density of polypropylene used herein is 0.895 g/cm³.

The oil and fat adsorbing nanofiber aggregate 1 satisfies formulae (i) and (ii) below where the oil and fat adsorbing nanofiber aggregate 1 has an average fiber diameter of d and a bulk density of ρ_{b}.

1000 nm≤d≤2000 nm (i)

0.01 g/cm³≤ρ_{b}≤0.2 g/cm³ (ii)

The oil and fat adsorbing nanofiber aggregate 1 more preferably satisfies formulae (i′) and (ii′) below.

1300 nm≤d≤1700 nm (i′)

0.01 g/cm³≤ρ_{b}≤0.05 g/cm³ (ii′)

The average fiber diameter is obtained as follows. In the oil and fat adsorbing nanofiber aggregate 1, a plurality of spots are arbitrarily selected and enlarged with an electron microscope. In each spot enlarged with the electron microscope, a plurality of nanofibers are arbitrarily selected to measure the diameters. The diameters of the selected nanofibers are then averaged to be defined as the average fiber diameter. In the present embodiment, five spots are arbitrarily selected in the oil and fat adsorbing nanofiber aggregate 1 and 20 nanofibers are arbitrarily selected in each spot to measure the diameters. Then, the average of the diameters of these 100 nanofibers is defined as the average fiber diameter. The coefficient of variation (value obtained by dividing the standard deviation by the average) is preferably 0.6 or less.

### Device and Method of Producing Oil and Fat Adsorbing Nanofiber Aggregate

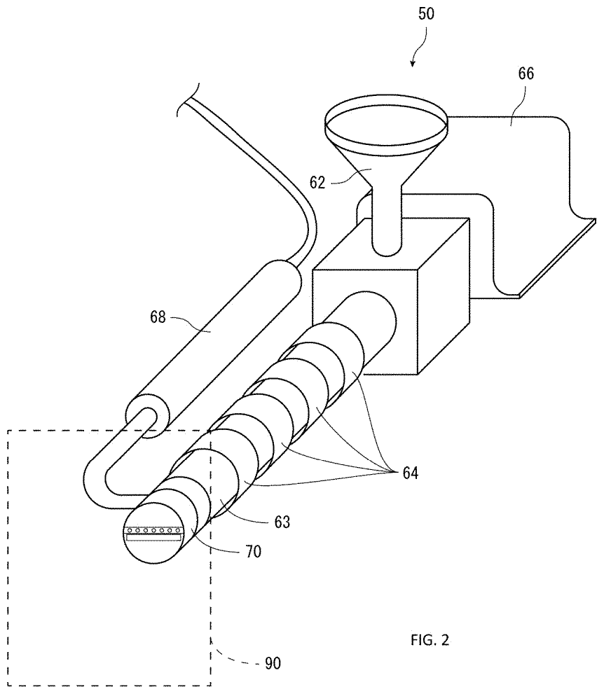

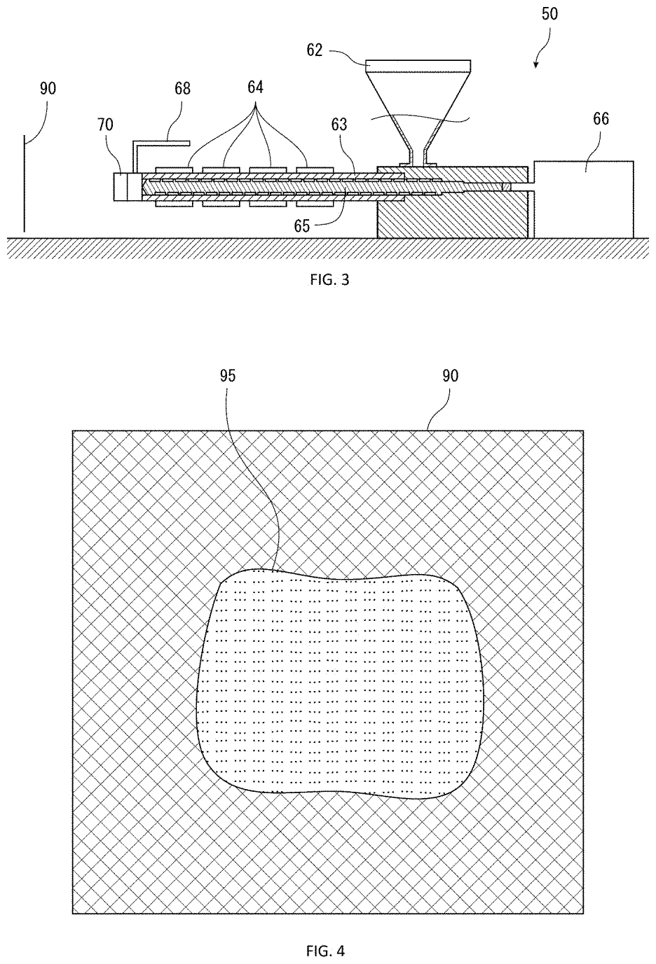

The oil and fat adsorbing nanofiber aggregate 1 in the present embodiment is produced using a production device illustrated in FIGS. 2 through 4. FIG. 2 is a perspective view illustrating an example of a production device used for preparation of the oil and fat adsorbing nanofiber aggregate in FIG. 1. FIG. 3 is a side view including a partial cross section of the production device in FIG. 2. FIG. 4 is a front view of a collecting net for deposition of nanofibers produced by the production device in FIG. 2.

As illustrated in FIGS. 2 and 3, a production device 50 has a hopper 62, a heating cylinder 63, heaters 64, a screw 65, a motor 66, and a head 70.

Into the hopper 62, a synthetic resin in the form of pellets is fed to be the material for the nanofibers. The heating cylinder 63 is heated by the heaters 64 to melt the resin supplied from the hopper 62. The screw 65 is accommodated in the heating cylinder 63. The screw 65 is rotated by the motor 66 to deliver the molten resin to a distal end of the heating cylinder 63. The head 70 in a cylindrical shape is provided at the distal end of the heating cylinder 63. To the head 70, a gas supply section, not shown, is connected via a gas supply pipe 68. The gas supply pipe 68 is provided with a heater to heat high pressure gas supplied from the gas supply section. The head 70 injects the high pressure gas to the front and also discharges the molten resin so as to be carried on the high pressure gas flow. In front of the head 70, a collecting net 90 is arranged.

Now, operation of the production device 50 in the present embodiment is described. The raw material (resin) in the form of pellets fed into the hopper 62 is supplied into the heating cylinder 63. The resin melted in the heating cylinder 63 is delivered to the distal end of the heating cylinder 63 by the screw 65. The molten resin (molten raw material) reaching the distal end of the heating cylinder 63 is discharged from the head 70. In coincidence with the discharge of the molten resin, high pressure gas is blown from the head 70.

The molten resin discharged from the head 70 intersects with the gas flow at a predetermined angle and is carried forward while being drawn. The drawn resin becomes fine fibers to be aggregated, as illustrated in FIG. 4, on the collecting net 90 arranged in front of the head 70 (aggregation step). The aggregated fine fibers 95 are then formed in a desired shape (e.g., square mat shape) (formation step). The oil and fat adsorbing nanofiber aggregate 1 of the present invention is thus obtained.

It should be noted that, although configured to discharge the “molten raw material” obtained by heating a synthetic resin to be a raw material to melt the resin, the above production device 50 is not limited to this configuration. In addition to this configuration, the production device 50 may be configured to, for example, discharge a “solvent” where a solid or liquid raw material as a solute is dissolved in advance at a predetermined concentration relative to a predetermined solvent. The present applicant discloses, as an example of a production device applicable to production of the oil and fat adsorbing nanofiber aggregate 1, a nanofiber production device and a nanofiber production method in Japanese Patent Application No. 2015-065171. The application was granted a patent (Japanese Patent No. 6047786, filed on Mar. 26, 2015 and registered on Dec. 2, 2016) and the present applicant holds the patent right.

### Modeling of Fiber Aggregate

The present inventors attempted to specify the structure of the fiber aggregate having a structure in which many fibers are complexly entangled with each other. The present inventors construed the structure of the fiber aggregate by simplification and developed a model by assuming that the fiber aggregate contains a plurality of fibers extending in three directions orthogonal to each other in a minimum calculation unit in a cubic shape.

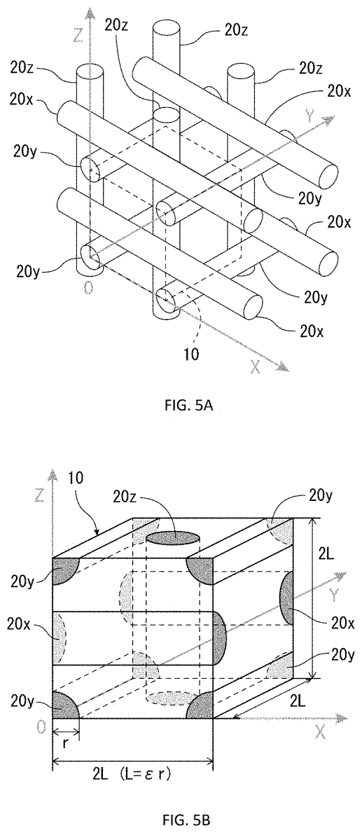

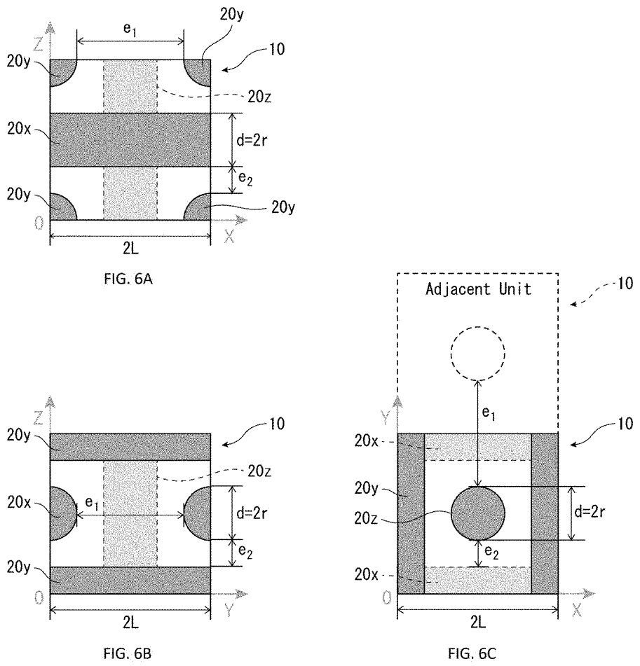

FIGS. 5 and 6 illustrate the model thus developed. FIG. 5A is a perspective view illustrating a three-direction model and a unit-calculation unit of the fiber aggregate. FIG. 5B is a perspective view of the minimum calculation unit. FIGS. 6A, 6B, and 6C are diagrams of the minimum calculation unit taken from the Y axis direction, the X axis direction, and the Z axis direction. In FIG. 6C, an adjacent minimum calculation unit (adjacent unit) is indicated by a broken line.

As illustrated in FIGS. 5 and 6, in a three-dimensional space represented by the X, Y, and Z axes, a minimum calculation unit 10 has a cubic shape with each side 2L in length. The minimum calculation unit 10 includes fiber portions 20x, 20y, and 20z. The fiber portions 20x have the central axis located on two planes in parallel with the X axis and the Z axis and extending in the X axis direction. The fiber portions 20x have a cross-sectional shape of a semicircular shape obtained by bisecting a circle. The fiber portions 20y have the central axis coinciding with four sides in parallel with the Y axis and extending in the Y axis direction. The fiber portions 20y have a cross-sectional shape of a sector obtained by quadrisecting a circle. The fiber portion 20z has the central axis extending in the Z axis direction through two planes in parallel with the X axis and the Y axis. The fiber portion 20z has a cross-sectional shape of a circular shape. The fiber portions 20x, 20y, and 20z are arranged at intervals to each other. The total volume of the fiber portions 20x, the total volume of the fiber portions 20y, and the volume of the fiber portion 20z are identical.

In the minimum calculation unit 10, a length coefficient ϵ can be expressed by a formula (1) below where d denotes the fiber diameter, r denotes the fiber radius, and 2L denotes the distance between the central axes of parallel fibers.

$$\begin{matrix}[ \text{Math 4} ] & \\ ɛ = \frac{L}{r} ( ɛ \geq 1 , 2 L = 2 ɛ r = ɛ d ) & ( 1 )\end{matrix}$$

In addition, the relationship of a formula (2) below holds for a mass m of the minimum calculation unit 10, a volume of V, a fiber diameter of d=2r, and a fiber density of ρ. It should be noted that the density ρ of each fiber constituting the oil and fat adsorbing nanofiber aggregate 1 in the present embodiment is considered to be equivalent to the density of polypropylene in a solid state. In the calculation using the formulae herein, the density of polypropylene is thus used as the fiber density p.

[Math 5]

m=6πr²Lρ (2)

The fiber aggregate has a bulk density pb that can be expressed by a formula (3) below.

$$\begin{matrix}[ \text{Math 6} ] & \\ {ρ}_{b} = \frac{m}{V} = \frac{6 π {r}^{2} L ρ}{8 {L}^{3}} = \frac{3 π}{4 {ɛ}^{2}} ρ & ( 3 )\end{matrix}$$

The fiber aggregate has a porosity η (free volume η) that can be expressed by a formula (4) below.

$$\begin{matrix}[ \text{Math 7} ] & \\ η = \frac{8 {L}^{3} - 6 π {r}^{2} L}{8 {L}^{3}} = 1 - \frac{3 π}{4 {ɛ}^{2}} = 1 - \frac{{ρ}_{b}}{ρ} & ( 4 )\end{matrix}$$

An interfiber distance e₁ (gap e₁) can be expressed by a formula (5) below.

$$\begin{matrix}[ \text{Math 8} ] & \\ {e}_{1} = 2 L - 2 r = d ( \sqrt{\frac{3 π}{4 ( 1 - η )}} - 1 ) & ( 5 )\end{matrix}$$

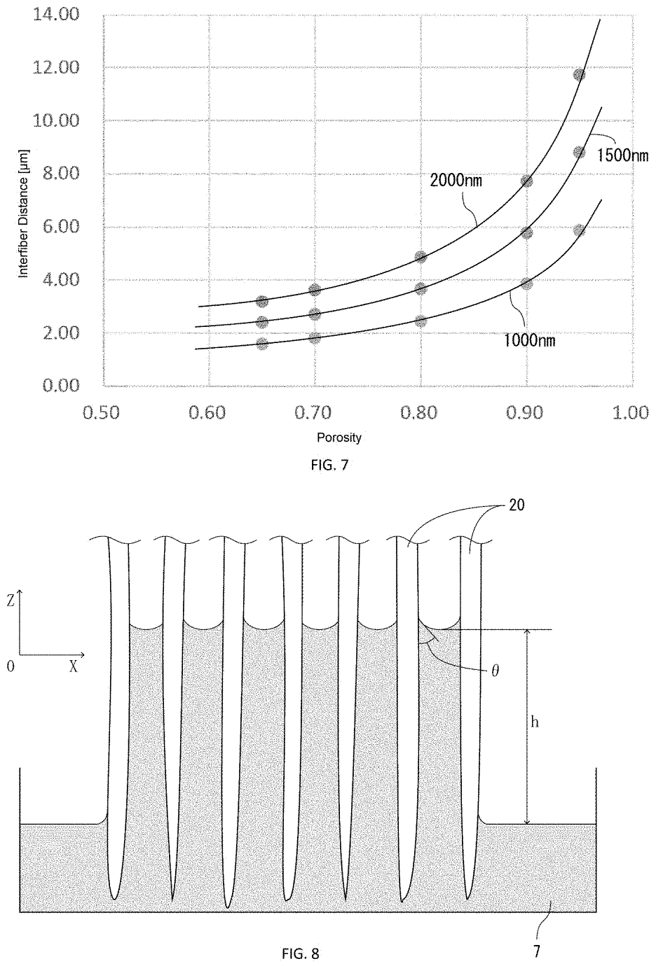

FIG. 7 illustrates a graph created using the result of calculating the formula (5). This graph illustrates the relationship between the porosity η and the interfiber distance e₁ in each of a plurality of fiber aggregates constituted by fibers with different average fiber diameters d (1000 nm, 1500 nm, 2000 nm).

In the oil and fat adsorbing nanofiber aggregate 1 as a fiber aggregate configured to have an average fiber diameter d of 1000 nm and a bulk density of 0.2 g/cm³ (porosity of 0.7765), the interfiber distance e₁ is obtained as 2.3 μm from the formula (5). In the oil and fat adsorbing nanofiber aggregate 1 configured to have an average fiber diameter d of 2000 nm and a bulk density of 0.01 g/cm³ (porosity of 0.9888), the interfiber distance e₁ is obtained as 27.0 μm from the formula (5).

From FIGS. 6A and 8, a formula (6) below holds for a surface tension of oil or fat to be adsorbed of T, a contact angle of the oil or fat of θ, an oil and fat density of ρₒ, a gravitational acceleration of g, and a suction height of h when the force in the Z direction (vertical direction) is in equilibrium.

[Math 9]

2πrT cos θ={(e₁+2r)²−πr²}ρₒgh (6)

The formula (6) above is based on the following references.
(a) Yuehua YUAN and T. Randall LEE, Contact Angle and Wetting Properties, Surface Science Techniques, ISBN: 978-3-642-34242-4, (2013), pp. 3-34.
(b) Tiina Rasilainen, Controlling water on polypropylene surfaces with micro- and micro/nanostructures, Department of CHEMISTRY, University of Eastern Finland, (2010), pp. 1-42.
(c) Thawatchai Phaechamud and Chirayu Savedkairop, Contact Angle and Surface Tension of Some Solvents Used in Pharmaceuticals, Research Journal of Pharmaceutical, Biological and Chemical Sciences, ISSN: 0975-8585, Vol. 3, Issue. 4, (2012), pp. 513-529.
(d) Keizo OGINO and Ken-ichi SHIGEMURA, Studies of the Removal of Oily Soil by Rolling-up in Detergency. II. On Binary Soil Systems Consisting of Oleic Acid and Liquid Paraffin, BULLETIN OF THE CHEMICAL SOCIETY OF JAPAN, Vol. 49 (11), (1976), pp. 3236-3238.
(e) Victoria Broje and Arturo A. Keller, Interfacial interactions between hydrocarbon liquids and solid surfaces used in mechanical oil spill recovery, Journal of Colloid and Interface Science, Vol. 305, (2007), pp. 286-292.

From the formula (6) above, a suction height h in the Z direction can be obtained by a formula (7) below.

$$\begin{matrix}[ \text{Math 10} ] & \\ h = \frac{2 π r T cos θ}{\{ {( {e}_{1} + 2 r )}^{2} - π {r}^{2} \} {ρ}_{o} g} & ( 7 )\end{matrix}$$

In addition, a formula (8) below holds for, in the minimum calculation unit 10, a mass before oil and fat adsorption (own weight) of m and a mass after oil and fat adsorption of M.

$$\begin{matrix}[ \text{Math 11} ] & \\ \frac{M}{m} = 1 + \frac{4 η {ɛ}^{2} {ρ}_{o}}{3 π ρ} = 1 + \frac{η {ρ}_{o}}{( 1 - η ) ρ} & ( 8 )\end{matrix}$$

The formula (8) enables calculation of an estimate of a suction rate M/m using the porosity η, the fiber density ρ, and the oil and fat density ρₒ as parameters allowed to be obtained before oil and fat adsorption.

The volume V after oil and fat adsorption in the minimum calculation unit 10 is a total value of a volume of the oil and fat adsorbing fiber aggregate (v_{fiber}) and a volume of adsorbed oil and fat (vₒᵢₗ). Where the volume before oil and fat adsorption in the minimum calculation unit 10 is Vₙ, a volume expansion ratio V/Vₙ can be expressed by formulae (9) and (10) below.

$$\begin{matrix}[ Math 12 ] & \\ V = {v}_{oil} + {v}_{{ }^{fiber}} = \frac{( M \text{/} m ) m - m}{{ρ}_{0}} + \frac{m}{ρ} & ( 9 )\end{matrix}$$

The formula (8) above enables estimation of the suction rate M/m and further calculation of the estimate of the volume V after oil and fat adsorption using the mass m before oil and fat adsorption, the fiber density ρ, and the oil and fat density ρₒ the fiber density as parameters allowed to be obtained before oil and fat adsorption by the formula (9).

$$\begin{matrix}[ \text{Math 13} ] & \\ \frac{V}{{V}_{n}} = \frac{V}{m \text{/} {ρ}_{b}} = \frac{V ρ ( 1 - η )}{{ρ}_{o}} = {( \frac{{ɛ}^{′}}{ɛ} )}^{3} & ( 10 )\end{matrix}$$

In the formula (10), ϵ denotes a length coefficient before oil and fat adsorption in the minimum calculation unit 10 and ϵ′ denotes a length coefficient after oil and fat adsorption.

Although the respective calculation formulae described above are for the minimum calculation unit 10, the respective calculation formulae are also applicable to the oil and fat adsorbing nanofiber aggregate 1 considering that the oil and fat adsorbing nanofiber aggregate 1 is composed by collecting a number of minimum calculation units 10.

### Verification

The present inventors then prepared oil and fat adsorbing nanofiber aggregates in Examples 1-1 through 1-8 and Comparative Examples 1-1, 1-2, 2-1, 2-2, 3-1, 3-2, 4, and 5 of the present invention described below to verify performance on oil and fat adsorption using them.

### Examples 1-1 Through 1-8

Using the production device 50 described above, fine fibers 95 with an average fiber diameter of 1500 nm were produced from polypropylene as a material. The standard deviation of the fiber diameter was 900 and the coefficient of variation obtained by dividing the standard deviation by the average fiber diameter was 0.60. The deposited fine fibers 95 were formed to have a bulk density of 0.01 [g/cm³], 0.03 [g/cm³], 0.04 [g/cm³], 0.05 [g/cm³], 0.09 [g/cm³], 0.1 [g/cm³], 0.13 [g/cm³], and 0.2 [g/cm³] to obtain the oil and fat adsorbing nanofiber aggregates in Examples 1-1 through 1-8. When Examples 1-1 through 1-8 were applied to the above model, the interfiber distance e₁ calculated from the formula (5) became 20.3 μm, 11.1 μm, 9.4 μm, 8.2 μm, 5.8 μm, 5.4 μm, 4.5 μm, and 3.4 μm.

### Comparative Examples 1-1 and 1-2

Using the production device 50 described above, fine fibers 95 with an average fiber diameter of 800 nm were produced from polypropylene as a material. The standard deviation of the fiber diameter was 440 and the coefficient of variation obtained by dividing the standard deviation by the average fiber diameter was 0.55. The deposited fine fibers 95 were formed to have a bulk density of 0.01 [g/cm³] and 0.1 [g/cm³] to obtain the oil and fat adsorbing nanofiber aggregates in Comparative Examples 1-1 and 1-2. When Comparative Examples 1-1 and 1-2 were applied to the above model, the interfiber distance e₁ calculated from the formula (5) became 10.8 μm and 2.9 μm.

### Comparative Examples 2-1 and 2-1

Using the production device 50 described above, fine fibers 95 with an average fiber diameter of 4450 nm were produced from polypropylene as a material. The standard deviation of the fiber diameter was 2280 and the coefficient of variation obtained by dividing the standard deviation by the average fiber diameter was 0.51. The deposited fine fibers 95 were formed to have a bulk density of 0.01 [g/cm³] and 0.1 [g/cm³] to obtain the oil and fat adsorbing nanofiber aggregates in Comparative Examples 2-1 and 2-2. When Comparative Examples 2-1 and 2-2 were applied to the above model, the interfiber distance e₁ calculated from the formula (5) became 60.2 μm and 16.0 μm.

### Comparative Examples 3-1 and 3-2

Using the production device 50 described above, fine fibers 95 with an average fiber diameter of 7700 nm were produced from polypropylene as a material. The standard deviation of the fiber diameter was 4360 and the coefficient of variation obtained by dividing the standard deviation by the average fiber diameter was 0.57. The deposited fine fibers 95 were formed to have a bulk density of 0.01 [g/cm³] and 0.1 [g/cm³] to obtain the oil and fat adsorbing nanofiber aggregates in Comparative Examples 3-1 and 3-2. When Comparative Examples 3-1 and 3-2 were applied to the above model, the interfiber distance e₁ calculated from the formula (5) became 104.1 μm and 27.7 μm.

### Comparative Example 4

Using the production device 50 described above, fine fibers 95 with an average fiber diameter of 1500 nm were produced from polypropylene as a material. The standard deviation of the fiber diameter was 900 and the coefficient of variation obtained by dividing the standard deviation by the average fiber diameter was 0.60. The deposited fine fibers 95 were formed to have a bulk density of 0.3 [g/cm³] to obtain the oil and fat adsorbing nanofiber aggregate in Comparative Example 4. When Comparative Example 4 was applied to the above model, the interfiber distance e₁ calculated from the formula (5) became 2.5 μm.

### Comparative Example 5

Using the production device 50 described above, fine fibers 95 with an average fiber diameter of 1500 nm were produced from polypropylene as a material. The standard deviation of the fiber diameter was 900 and the coefficient of variation obtained by dividing the standard deviation by the average fiber diameter was 0.60. The deposited fine fibers 95 were formed to have a bulk density of 0.49 [g/cm³] to obtain the oil and fat adsorbing nanofiber aggregate in Comparative Example 5. When Comparative Example 5 was applied to the above model, the interfiber distance e₁ calculated from the formula (5) became 1.6 μm.

In Examples and Comparative Examples above, the coefficients of variation in fiber diameter ranged from 0.55 to 0.60 and were substantially identical.

Table 1 presents a list of configurations in Examples and Comparative Examples above.

TABLE 1

| | Average Fiber | Bulk Density | | Interfiber |
|---|---|---|---|---|
| | Diameter [nm] | [g/cm³] | Porosity | Distance [μm] |
| Example 1-1 | 1500 | 0.01 | 0.9888 | 20.3 |
| Example 1-2 | 1500 | 0.03 | 0.9665 | 11.1 |
| Example 1-3 | 1500 | 0.04 | 0.9553 | 9.4 |
| Example 1-4 | 1500 | 0.05 | 0.9441 | 8.2 |
| Example 1-5 | 1500 | 0.09 | 0.8994 | 5.8 |
| Example 1-6 | 1500 | 0.1 | 0.8883 | 5.4 |
| Example 1-7 | 1500 | 0.13 | 0.8547 | 4.5 |
| Example 1-8 | 1500 | 0.2 | 0.7765 | 3.4 |
| Comparative | 800 | 0.01 | 0.9888 | 10.8 |
| Example 1-1 | | | | |
| Comparative | 800 | 0.1 | 0.8883 | 2.9 |
| Example 1-2 | | | | |
| Comparative | 4450 | 0.01 | 0.9888 | 60.2 |
| Example 2-1 | | | | |
| Comparative | 4450 | 0.1 | 0.8883 | 16.0 |
| Example 2-2 | | | | |
| Comparative | 7700 | 0.01 | 0.9888 | 104.1 |
| Example 3-1 | | | | |
| Comparative | 7700 | 0.1 | 0.8883 | 27.7 |
| Example 3-2 | | | | |
| Comparative | 1500 | 0.3 | 0.6648 | 2.5 |
| Example 4 | | | | |
| Comparative | 1500 | 0.49 | 0.4525 | 1.6 |
| Example 5 | | | | |

### Verification 1: Relationship 1 Between Average Fiber Diameter and Suction Rate

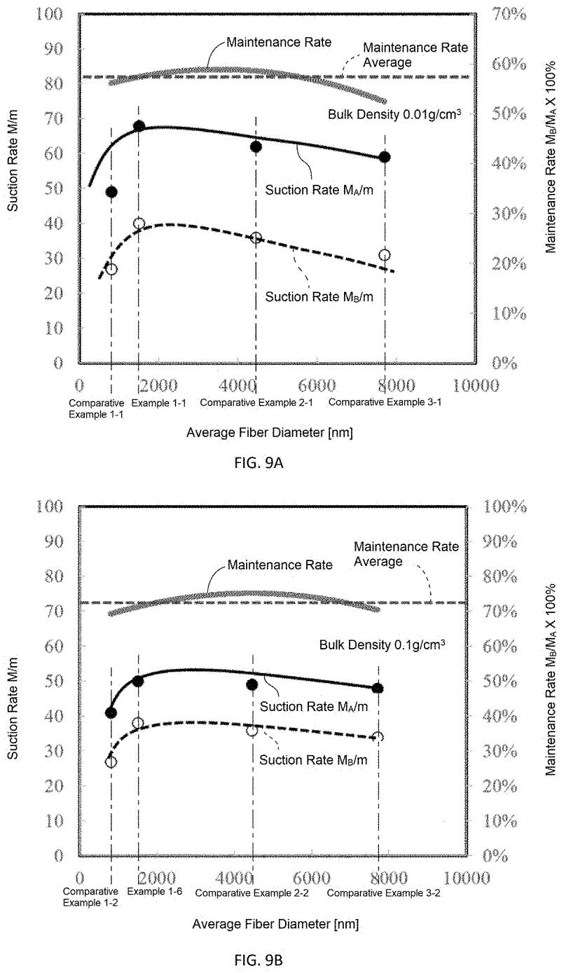

Using Examples 1-1 and 1-6 and Comparative Examples 1-1, 1-2, 2-1, 2-2, 3-1, and 3-2 above, cylindrical test pieces with a diameter of 18 mm and a height of 2 mm were prepared to measure the mass m before oil and fat adsorption for each using a high precision electronic balance. The test pieces were then immersed in oil to be adsorbed (machine oil (ISOVG: 46) produced by TRUSCO, specific gravity ρₒ=850 kg/m³, contact angle from 29 to 35 degrees). After sufficient time for saturation of the oil adsorption amount, the test pieces were taken out of the oil and placed on a wire gauze to naturally drop the adsorbed oil. Then, using a high precision electronic balance, a mass M_{A} immediately (0 seconds) after taken out of the oil and a mass M_{B} 30 seconds after taken out were measured. Values obtained by dividing the mass M_{A} and the mass M_{B} by the mass m were defined as suction rates M/m (M_{A}/m, M_{B}/m). A value obtained by dividing the mass M_{B} by the mass M_{A} and then multiplied by 100 was defined as a maintenance rate M_{B}/M_{A}×100 [%]. FIG. 9A illustrates the relationship of average fiber diameter with suction rate and maintenance rate in Example 1-1 and Comparative Examples 1-1, 2-1, and 3-1. FIG. 9B illustrates the relationship of average fiber diameter with suction rate and maintenance rate in Example 1-6 and Comparative Examples 1-2, 2-2, and 3-2.

As clearly seen from FIGS. 9A and 9B, Examples 1-1 and 1-2 exhibited excellent suction rates compared with those in Comparative Examples 1-1, 1-2, 2-1, 2-2, 3-1, and 3-2. In particular, both suction rates M_{A}/m and M_{B}/m became relatively high for an average fiber diameter from 1000 nm to 2000 nm and reached the respective peaks for an average fiber diameter around 1500 nm.

### Verification 2: Relationship 2 Between Thickness of Fiber Aggregate and Suction Rate

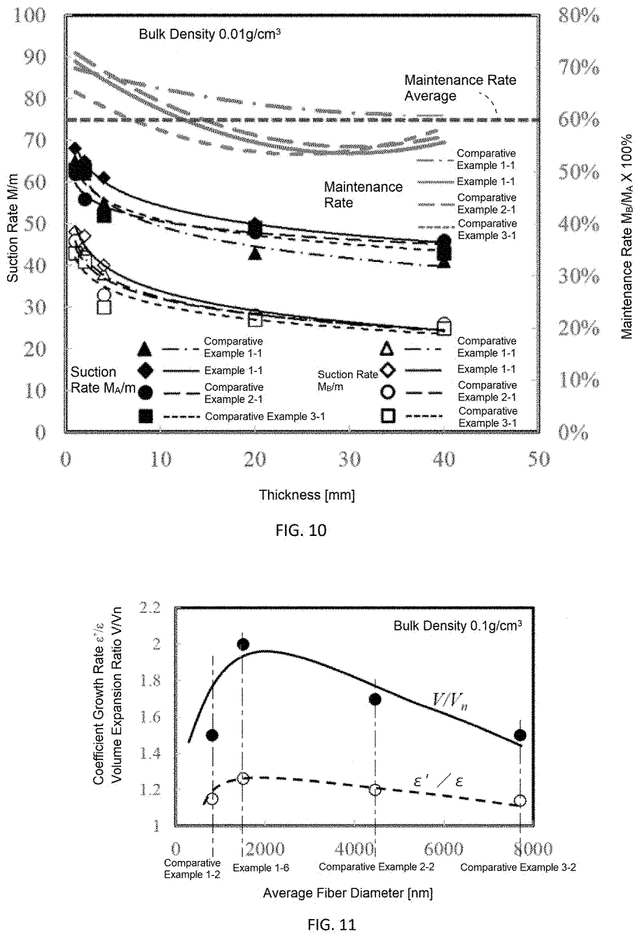

Using Example 1-1 and Comparative Examples 1-1, 2-1, and 3-1 above, cylindrical test pieces with a diameter of 18 mm and a height (thickness t) of 1 mm, 2 mm, 4 mm, 20 mm, and 40 mm were prepared to measure the mass m before oil and fat adsorption for each using a high precision electronic balance. The test pieces were then immersed in oil to be adsorbed (machine oil (ISOVG: 46) produced by TRUSCO, specific gravity ρₒ=850 kg/m³, contact angle from 29 to 35 degrees). After sufficient time for saturation of the oil adsorption amount, the test pieces were taken out of the oil and placed on a wire gauze to naturally drop the adsorbed oil. Then, using a high precision electronic balance, the mass M_{A} immediately (0 seconds) after taken out of the oil and the mass M_{B} 30 seconds after taken out were measured. Values obtained by dividing the mass M_{A} and the mass M_{B} by the mass m were defined as the suction rates M/m (M_{A}/m, M_{B}/m). A value obtained by dividing the mass M_{B} by the mass M_{A} and then multiplied by 100 was defined as the maintenance rate M_{B}/M_{A}×100 [%]. FIG. 10 illustrates the relationship of thickness of each test piece with suction rate and maintenance rate in Example 1-1 and Comparative Examples 1-1, 2-1, and 3-1.

As clearly seen from FIG. 10, Example 1-1 exhibited the highest suction rate for any height of the test pieces. For any average fiber diameter, a smaller thickness of the test piece resulted in a higher suction rate. This is considered because, while the fibers in a lower portion of each test piece supports those in an upper portion, the oil in the lower portion comes out of the test piece due to the oil in the upper portion and a greater thickness of the test piece results in a greater amount of the oil to come out. In addition, a smaller thickness of the test piece failed to sufficiently secure the amount of oil and fat to be adsorbed while exhibiting a high suction rate. For these reasons, the oil and fat adsorbing nanofiber aggregate preferably has the thickness t satisfying a formula (iii) below.

2 mm≤t≤5 mm (iii)

Verification 3: Relationship of Average Fiber Diameter with Coefficient Growth Rate and Volume Expansion Ratio

Using Example 1-6 and Comparative Examples 1-2, 2-2, and 3-2 above, cylindrical test pieces with a diameter of 18 mm and a height of 2 mm were prepared to measure the mass m before oil and fat adsorption for each using a high precision electronic balance. The test pieces were then immersed in oil to be adsorbed (machine oil (ISOVG: 46) produced by TRUSCO, specific gravity ρₒ=850 kg/m³, contact angle from 29 to 35 degrees). After sufficient time for saturation of the oil adsorption amount, the test pieces were taken out of the oil and placed on a wire gauze to naturally drop the adsorbed oil. Then, using a high precision electronic balance, a mass M five minutes after taken out of the oil was measured. The mass m and the mass M were applied to the formulae (8) through (10) above to obtain a coefficient growth rate ϵ′/ϵ. Then, from the coefficient growth rate ϵ′/ϵ, a volume expansion ratio V/Vn was obtained. FIG. 11 illustrates the relationship of an average fiber diameter with coefficient growth rate and volume expansion ratio in Example 1-6 and Comparative Examples 1-2, 2-2, and 3-2.

As clearly seen from FIG. 11, Example 1-2 exhibited excellent coefficient growth rate and volume expansion ratio compared with those in Comparative Examples 1-2, 2-2, and 3-2. In addition, both the coefficient growth rate and the volume expansion ratio became relatively high for an average fiber diameter from 1000 nm to 2000 nm and reached the respective peaks of the coefficient growth rate and the volume expansion ratio for an average fiber diameter around 1500 nm.

### Verification 4: Relationship Between Bulk Density and Suction Rate

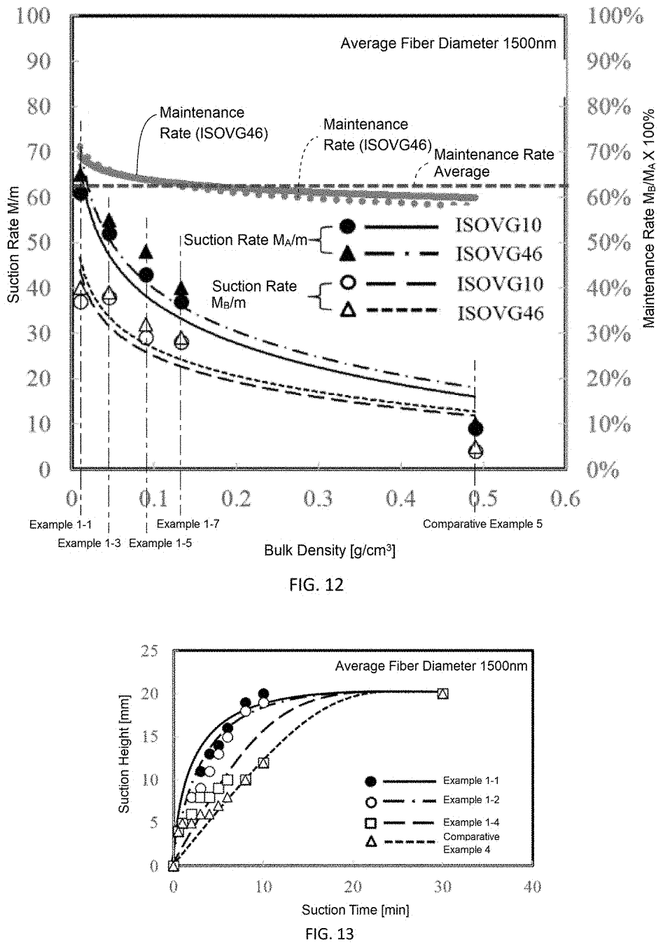

Using Examples 1-1, 1-3, 1-5, and 1-7 and Comparative Example 5 above, cylindrical test pieces with a diameter of 18 mm and a height of 2 mm were prepared to measure the mass nn before oil and fat adsorption for each using a high precision electronic balance. The test pieces were then immersed in oil [1] to be adsorbed (machine oil (ISOVG: 46) produced by TRUSCO) and oil [2] to be adsorbed (machine oil (ISOVG: 10) produced by TRUSCO). After sufficient time for saturation of the oil adsorption amount, the test pieces were taken out of the oils and placed on a wire gauze to naturally drop the adsorbed oil. Then, using a high precision electronic balance, the mass M_{A} immediately (0 seconds) after taken out of the oil and the mass M_{B} 30 seconds after taken out were measured. Values obtained by dividing the mass M_{A} and the mass M_{B} by the mass nn were defined as the suction rates M/m (M_{A}/m, M_{B}/m). A value obtained by dividing the mass M_{B} by the mass M_{A} and then multiplied by 100 was defined as the maintenance rate M_{B}/M_{A}×100 [%]. FIG. 12 illustrates the relationship of bulk density with suction rate and maintenance rate in Examples 1-1, 1-3, 1-5, and 1-7 and Comparative Example 5.

As clearly seen from FIG. 12, regardless of the viscosity of the oils, a smaller bulk density resulted in higher suction rates both M_{A}/m and M_{B}/m. In particular, for a bulk density of 0.2 g/cm³ or less, a smaller bulk density caused even greater degrees of increase in both suction rates.

### Verification 5: Relationship Between Bulk Density and Suction Speed

Using Examples 1-1, 1-2, and 1-4 and Comparative Example 4 above, cylindrical test pieces with a diameter of 18 mm and a height of 20 mm were prepared. The test pieces were put in a container containing oil to be adsorbed (machine oil (ISOVG: 46) produced by TRUSCO, specific gravity ρₒ=850 kg/m³, contact angle from 29 to 35 degrees) up to a depth of 1 mm so as to immerse lower portions of the test pieces and a suction height for each piece was measured at each unit time. FIG. 13 illustrates the relationship between suction time and suction height in Examples 1-1, 1-2, and 1-4 and Comparative Example 4.

As clearly seen from FIG. 13, it was found that a smaller bulk density resulted in a higher suction speed to suck up the oil to the height of upper end (20 mm) in a shorter time period. In particular, the suction height reached 15 mm in less than 10 minutes for a bulk density of 0.2 g/cm³ or less and the suction speed was satisfactory.

### Verification 6: Relationship Between Volume Expansion Ratio and Suction Rate

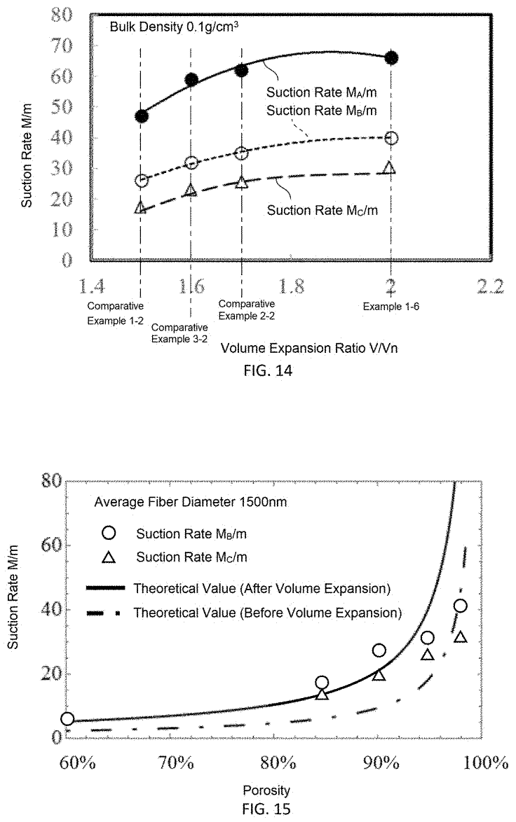

Using Example 1-6 and Comparative Examples 1-2, 2-2, and 3-2 above, cylindrical test pieces with a diameter of 18 mm and a height of 2 mm were prepared to measure the mass m before oil and fat adsorption for each using a high precision electronic balance. The test pieces were then immersed in oil to be adsorbed (machine oil (ISOVG: 46) produced by TRUSCO, specific gravity ρₒ=850 kg/m³, contact angle from 29 to 35 degrees). After sufficient time for saturation of the oil adsorption amount, the test pieces were taken out of the oil and placed on a wire gauze to naturally drop the adsorbed oil. Then, using a high precision electronic balance, the mass M_{A} immediately (0 seconds) after taken out of the oil, the mass M_{B} 30 seconds after taken out, and a mass M_{C} five minutes after taken out were measured. Values obtained by dividing the mass M_{A}, the mass M_{B}, and the mass M_{C} by the mass m were defined as the suction rates M/m (M_{A}/m, M_{B}/m, M_{C}/m). The mass m and the mass M were applied to the formulae (8) through (10) above to obtain the coefficient growth rate ϵ′/ϵ. From the coefficient growth rate ε′/ϵ, the volume expansion ratio V/Vn was obtained. FIG. 14 illustrates the relationship between volume expansion ratio and suction rate in Example 1-6 and Comparative Examples 1-2, 2-2, and 3-2.

As clearly seen from FIG. 14, both the coefficient growth rate and the volume expansion ratio for an average fiber diameter of 1500 nm resulted in the greatest volume expansion ratio and the highest suction rate and thus the oil was efficiently adsorbed.

From the results of Verifications 1 through 6 above, it was found that the oil and fat adsorbing nanofiber aggregates with an average fiber diameter from 1000 nm to 2000 nm and a bulk density from 0.01 g/cm³ to 0.2 g/cm³ had satisfactory performance of oil and fat adsorption. In particular, it was found that those with an average fiber diameter around 1500 nm (from 1300 nm to 1700 nm) and a bulk density from 0.01 g/cm³ to 0.05 g/cm³ had more satisfactory performance of oil and fat adsorption.

### Verification 7: Relationship Between Porosity and Suction Rate

A plurality of oil and fat adsorbing nanofiber aggregates with an average fiber diameter of 1500 nm and different porosities (i.e., bulk densities) were prepared to measure the mass m before oil and fat adsorption for each using a high precision electronic balance. The test pieces were then immersed in oil to be adsorbed (machine oil (ISOVG: 46) produced by TRUSCO, specific gravity ρₒ=850 kg/m³, contact angle from 29 to 35 degrees). After sufficient time for saturation of the oil adsorption amount, the test pieces were taken out of the oil and placed on a wire gauze to naturally drop the adsorbed oil. Then, using a high precision electronic balance, the mass M_{B} 30 seconds after taken out and the mass M_{C} five minutes after taken out were measured. Values obtained by dividing the mass M_{B} and the mass M_{C} by the mass m were defined as the suction rates M/m (M_{B}/m, M_{C}/m). Using the formula (8) above, a theoretical value of the suction rate relative to the porosity was calculated. FIG. 15 illustrates the relationship of porosity with actually measured values and theoretical values of the suction rate in the oil and fat adsorbing nanofiber aggregate with an average fiber diameter of 1500 nm.

As clearly seen from FIG. 15, the actually measured values roughly coincided with the theoretical values. This allowed approximate estimation of the suction rate M/m from the average fiber diameter and the bulk density (porosity) of the oil and fat adsorbing nanofiber aggregate and the model described above was thus confirmed to be useful.

Although the embodiments of the present invention have been described above, the present invention is not limited to these examples. The above embodiments subjected to addition, deletion, and/or design change of components appropriately by those skilled in the art and those having the characteristics of the embodiments appropriately combined are included in the scope of the present invention as long as including the spirit of the present invention.

### REFERENCE SIGNS LIST

1 Oil and Fat Adsorbing Nanofiber Aggregate
7 Oil and/or Fat
10 Minimum Calculation Unit
20 Fiber
20x, 20y, and 20z Fiber Portion
50 Production Device
62 Hopper
63 Heating Cylinder
64 Heater
65 Screw
66 Motor
68 Gas Supply Pipe
70 Head
90 Collecting Net
95 Fine Fiber
D Average Fiber Diameter
ρ_{b} Bulk Density
e₁ Interfiber Distance
η Porosity

1. An oil and fat adsorbing nanofiber aggregate, wherein
the oil and fat adsorbing nanofiber aggregate satisfies formulae (i) and (ii) below where the oil and fat adsorbing nanofiber aggregate has an average fiber diameter of d and a bulk density of ρ_{b}
1000 nm≤d≤2000 nm (i)
0.01 g/cm³≤ρ_{b}≤0.2 g/cm³ (ii).

2. The oil and fat adsorbing nanofiber aggregate according to claim 1, wherein the oil and fat adsorbing nanofiber aggregate further satisfies a formula (i′) below
1300 nm≤d≤1700 nm (i′).

3. The oil and fat adsorbing nanofiber aggregate according to claim 2, wherein the oil and fat adsorbing nanofiber aggregate further satisfies a formula (ii′) below
0.01 g/cm³≤ρ_{b}≤0.05 g/cm³ (ii′).

4. The oil and fat adsorbing nanofiber aggregate according to claim 1, wherein the oil and fat adsorbing nanofiber aggregate further satisfies a formula (iii) below where the oil and fat adsorbing nanofiber aggregate has a thickness of t
2 mm≤t≤5 mm (iii).

5. A method for estimating an oil and fat suction rate, estimating an oil and fat suction rate M/m indicating a ratio of a mass M after oil and fat adsorption to a mass m before oil and fat adsorption in an oil and fat adsorbing nanofiber aggregate, wherein
the method calculates an estimate of the oil and fat suction rate M/m by a formula (iv) below using a porosity η of the oil and fat adsorbing nanofiber aggregate, a density ρ of a fiber to constitute the oil and fat adsorbing nanofiber aggregate, and an oil and fat density ρₒ.
$$\begin{matrix}[ Math 1 ] & \\ \frac{M}{m} = 1 + \frac{η {ρ}_{o}}{( 1 - η ) ρ} & ( iv )\end{matrix}$$

6. A method for estimating a volume after oil and fat adsorption, estimating a volume V after oil and fat adsorption in an oil and fat adsorbing nanofiber aggregate, wherein
the method calculates an estimate of an oil and fat suction rate M/m indicating a ratio of a mass M after oil and fat adsorption to a mass m before oil and fat adsorption in the oil and fat adsorbing nanofiber aggregate by a formula (iv) below using a porosity η of the oil and fat adsorbing nanofiber aggregate, a density ρ of a fiber to constitute the oil and fat adsorbing nanofiber aggregate, and an oil and fat density ρₒ and
the method calculates an estimate of the volume V after oil and fat adsorption by a formula (v) below using the estimate of the oil and fat suction rate M/m, the mass m before oil and fat adsorption in the oil and fat adsorbing nanofiber aggregate, the density ρ of the fiber to constitute the oil and fat adsorbing nanofiber aggregate, the oil and fat density ρₒ.
$$\begin{matrix}[ Math 2 ] & \\ \frac{M}{m} = 1 + \frac{η {ρ}_{o}}{( 1 - η ) ρ} & ( iv ) \\ [ Math 3 ] & \\ V = \frac{( M \text{/} m ) m - m}{{ρ}_{o}} + \frac{m}{ρ} & ( v )\end{matrix}$$
